(19) United States
(12) Patent Application Publication
(10) Pub. No.: US 2008/0192802 A1
(43) Pub. Date: Aug. 14, 2008

(54) Colour Switching Temperature Indicator

(75) Inventors: Eduard Johannes Meijer, Eindhoven (NL); Rene Theodorus Wegh, Eindhoven (NL); Ralph Kurt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,906

(22) PCT Filed: Oct. 7, 2005
(86) PCT No.: PCT/IB05/53298

§ 371 Date: Apr. 9, 2007

(30) Foreign Application Priority Data
Oct. 15, 2004 (EP) 04105082.4

(51) Int. Cl. G01K 11/00

(52) U.S. Cl. 374/161; 374/E11.001

(57) ABSTRACT

A temperature indicator (101) is adapted to be provided on a surface (116) for providing a first type of light emission and a second type of light emission (L2). The temperature indicator (101) comprises a light-emitting diode (108) for providing said first type of light emission and a light-emitting electrochemical cell (109) for providing said second type of light emission (L2). The light-emitting electrochemical cell (109) has a first electrode (120), a second electrode (121) and a second light-emitting layer (113) being sandwiched between them and comprising a matrix and ions being movable in the matrix, the mobility of said ions in said matrix being temperature dependent. A power source (105) is adapted for driving the cell (109) with an AC voltage, the frequency of which is tuned in such a way that the cell (109) provides said second type of light emission (L2) when the surface temperature exceeds a certain level.

### FIELD OF THE INVENTION

The present invention relates to a temperature indicator adapted to be provided on a surface for providing a first type of light emission and a second type of light emission, the latter being emitted when the surface has a temperature being higher than a predetermined temperature.

### BACKGROUND OF THE INVENTION

In many appliances high temperatures are involved during use. Examples of such appliances are irons, water cookers, hot plates, oven windows, frying pans, toasters, waffle irons etc. In order to avoid injuries, such as burn injuries, to persons using such appliances there is a need to have an indicator indicating to the person using the appliance that it is hot and that care must be taken. Such indication of a high temperature is usually done by having a temperature sensor, a control unit coupled to the sensor and one or more lamps, that are lit by the control unit when the sensor registers a preset temperature. One example of such a system may be found in U.S. Pat. No. 6,396,027 B1 describing an iron having three indicator members that are controlled by a controller receiving signals from a temperature-sensing unit. A disadvantage with the type of temperature indicator described in U.S. Pat. No. 6,396,027 B1 is that it is complicated and requires the proper cooperation between several components in order to perform accurately in indicating whether the iron is hot or cold. A broken lamp may, as an example, give the user the incorrect impression that the iron is cold when it in the reality is hot. Furthermore, a temperature indicator of this type does not give any information as regards which part of the surface that is hot, if it is the entire surface or only a part of it.

### SUMMARY OF THE INVENTION

An object of the present invention is to provide a temperature indicator, which accurately and at low cost provides a safe indication of whether a surface is cold or hot.

This object is achieved by a temperature indicator adapted to be provided on a surface for providing a first type of light emission and a second type of light emission, the latter being emitted when the surface has a temperature being higher than a predetermined temperature, the temperature indicator comprising a light-emitting diode for providing said first type of light emission, the light-emitting diode having a first electrode, a second electrode and a first light-emitting layer being positioned between them, the temperature indicator further comprising a light-emitting electrochemical cell for providing said second type of light emission, the light-emitting electrochemical cell having a first electrode, a second electrode and a second light-emitting layer being positioned between them and comprising a matrix and ions being movable in the matrix, the mobility of said ions in said matrix being temperature dependent, the temperature indicator further comprising a power source adapted for driving the light-emitting electrochemical cell with an AC voltage, the frequency of which is tuned in such a way that the light-emitting electrochemical cell provides said second type of light emission when the surface temperature exceeds a certain level.

An advantage of this temperature indicator is that it provides an accurate indication of whether a surface is hot or cold since the type of light emitted, first type or second type, is an intrinsic property of the temperature indicator itself when the light-emitting electrochemical cell is driven with an AC voltage of a certain frequency. Due to the fact that the temperature indicator emits a first type of light, which is not dependent on high temperatures, the user may be informed of whether the temperature indicator is in operation or not also when the surface is cold. Since the temperature indicator is adapted to be placed onto a potentially hot surface there is no risk that the temperature indicated is not the relevant temperature of that surface. The temperature indicator is particularly suitable for covering large areas, such as almost the entire hot surface of an appliance, which decreases the risk that a user unintentionally touches any hot part of the appliance. The light-emitting electrochemical cell has no wear parts, such as a light bulb filament, and thus the risk of failure is minimal. In relation to the prior art, which requires a sensor, a control unit, a power source and warning lamps, the number of parts is reduced since, in the temperature indicator according to the invention, the light-emitting electrochemical cell will function both as sensor and warning lamp, and in a way also as a control system. This reduces the production cost and also reduces the risk that the temperature indicator fails to indicate a high temperature. In addition to providing the control of at which temperature the light emission should start the AC voltage also provides the advantage of preventing the ionic charge distribution from being more or less permanently “frozen” which may occur with a DC voltage as is described by G. Yu et al., Adv. Mater. 10, 385, 1998. Yet another advantage of the temperature indicator according to the invention is that it does not only indicate whether the surface is hot but also which part of if it that is hot. If a temperature indicator according to the invention is attached to the entire surface of e.g. the sole of an iron light emission of the second type will occur only in those parts of the surface where the temperature is high enough to make the light-emitting layer emit light of the second type according to the principles of the light-emitting cell.

An advantage with the measure according to claim 2 is that it provides for a thin temperature indicator which is suitable for covering large surfaces and which has few parts.

An advantage of the measure according to claim 3 is that the light-emitting diode and the light-emitting electrochemical cell could be spatially separated by a short or a long distance. Another advantage is that the light emitted by the diode does not interfere with the light emitted by the electrochemical cell.

An advantage of the measure according to claim 4 is that it provides for a very compact design of the temperature indicator since the diode and the electrochemical cell can form a common, thin, laminate. Further few parts are needed which makes the manufacturing cheaper. Another advantage is that when the diode and the electrochemical cell have common electrodes the risk that one of them would fail at the same time as the other one would work, which could provide the wrong impression of the temperature at the surface, is almost eliminated.

An advantage of the measure according to claim 5 is that the exact location in the light-emitting layers where holes and electrons recombine to emit light will depend on from which electrode, i.e. from which direction, they were injected. Thus it is possible to provide light-emitting layers with different properties on top of each other to obtain one type of light in one bias and another type of light in the opposite bias.

An advantage of the measure according to claim 6 is that it provides for injection of holes and electrons also at low temperatures, which makes it possible to provide a first type of light also when the surface is cold.

An advantage of the measure according to claim 7 is that it provides for a thin laminate in which the light-emitting layer of the diode and of the light-emitting electrochemical cell are not stacked directly on top of each other. This provides a greater degree of freedom in choosing the material for the first light-emitting layer and the second light-emitting layer.

An advantage of the measure according to claim 8 is that it provides for an automatic dimming of the first type of light as the resistance of the electrochemical cell decreases with increasing temperature and makes most of the current pass the electrochemical cell and not the diode.

An advantage of the measures according to claim 9 and claim 10 is that they are preferable ways of making the second type of light being the predominant one at higher temperatures since the light-emitting electrochemical cell is provided with more electric power than the light-emitting diode.

An advantage of the measure according to claim 11 is that a second type of light having one colour point, i.e. corresponding to red or orange light, and the first type of light having another colour point, i.e. corresponding to, for example, blue or green light, provides an easily understandable visual indication of the temperature. As alternative, or preferably in addition to having different colour points, the intensity of the second type of light could be made stronger than the intensity of the first type of light to provide the desired visual indication of the temperature.

An advantage of the measure according to claim 12 is that such a temperature indicator would not only indicate that a surface is hot, but would additionally indicate which parts of the surface are the hottest and which parts are cold and could be touched. Thus the risk that a user unintentionally touches a hot part of the surface is minimized.

An advantage of the measure according to claim 13 is that thermal contacts extending through the light-emitting electrochemical cell provides for improved heat transfer through the cell and decreases any unwanted insulating effects.

These and other aspects of the invention will be apparent from and elucidated with reference to the embodiments described hereinafter.

### BRIEF DESCRIPTION OF THE DRAWINGS

The invention will now be described in more detail with reference to the appended drawings in which:

FIG. 1 is a three-dimensional view and shows schematically a temperature indicator provided on the entire sole of an iron.

FIG. 2 is a partial section view and shows the temperature indicator along section II-II of FIG. 1.

FIG. 3a is an enlarged section view and shows the portion III of FIG. 2 at a first occasion and at a temperature of the sole of 25° C.

FIG. 3b is an enlarged section view and shows the view of FIG. 3a at a second occasion at a temperature of the sole of 25° C.

FIG. 3c is an enlarged section view and shows the view of FIG. 3a at a third occasion at a temperature of the sole of 25° C.

FIG. 3d is an enlarged section view and shows the view of FIG. 3a at a fourth occasion at a temperature of the sole of 25° C.

FIG. 4a is an enlarged section view and shows the portion III of FIG. 2 at a first occasion and at a temperature of the sole of 90° C.

FIG. 4b is an enlarged section view and shows the view of FIG. 4a at a second occasion at a temperature of the sole of 90° C.

FIG. 4c is an enlarged section view and shows the view of FIG. 4a at third occasion at a temperature of the sole of 90° C.

FIG. 4d is an enlarged section view and shows the view of FIG. 4a at a fourth occasion at a temperature of the sole of 90° C.

FIG. 5 is a diagram and indicates the light emission from the temperature indicator at different temperatures.

FIG. 6a is a section view and shows a temperature indicator according to a second embodiment at a first temperature.

FIG. 6b shows the temperature indicator of FIG. 6a at the first temperature but at the opposite polarity of the voltage.

FIG. 7a shows the temperature indicator of FIG. 6a at a second temperature.

FIG. 7b shows the temperature indicator of FIG. 7a at the second temperature but at the opposite polarity of the voltage.

FIG. 8a is a section view and shows a temperature indicator according to a third embodiment.

FIG. 8b shows the temperature indicator of FIG. 8a but at the opposite polarity of the voltage.

FIG. 9 is a top view and shows a temperature indicator according to another embodiment of the invention.

FIG. 10 is a cross section and shows the temperature indicator of FIG. 9 along the line X-X.

FIG. 11 is a top view and shows a temperature indicator of yet another embodiment of the invention.

### DESCRIPTION OF PREFERRED EMBODIMENTS

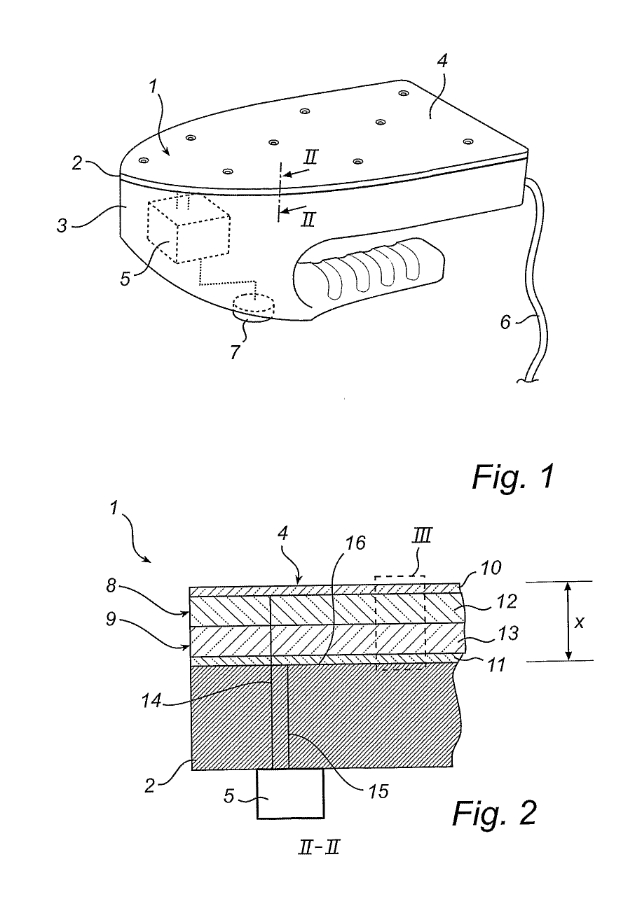

FIG. 1 shows schematically a temperature indicator 1 according to a first embodiment of the invention. The temperature indicator 1 covers the entire sole 2 of an iron 3. The temperature indicator 1 comprises, as will be described below, a light-emitting diode and a light-emitting electrochemical cell, forming together a light-emitting laminate 4, and an AC power source 5 adapted to drive the light-emitting laminate 4 with a low frequency AC voltage. The AC power source 5 is connected to the main electricity system (not shown in FIG. 1) of the iron 3 and provides the light-emitting laminate 4 with an AC voltage all the time the electrical cable 6 of the iron 3 is connected to a power supply. An AC voltage frequency modulator 7 could optionally be included in the temperature indicator 1 in order to enable fine-tuning of the temperature at which the light emission should change, as will be explained below.

FIG. 2 is a cross section showing the light-emitting laminate 4 having the shape of a thin laminate provided on the sole 2. The light-emitting laminate 4 comprises the light-emitting diode 8 and the light-emitting electrochemical cell 9 that have been built together to form the laminate 4 which, depending on the conditions, works as a light-emitting diode and/or as a light-emitting electrochemical cell depending on the conditions, as will be described below. The light-emitting diode 8 comprises a first electrode 10, a second electrode 11 and a first light-emitting layer 12 sandwiched between the electrodes 10, 11. The light-emitting electrochemical cell 9 comprises a first electrode being the same as the first electrode 10 of the light-emitting diode 8, a second electrode which is the same as the second electrode 11 of the light-emitting diode 8, and a second light-emitting layer 13 which is also sandwiched between the electrodes 10, 11 and is located under the first light-emitting layer 12 as shown in FIG. 2. Thus the light-emitting diode 8 and the light-emitting electrochemical cell 9 have the first electrode 10 and the second electrode 11 in common. The basic principle of a light-emitting electrochemical cell is per se known from Q. B. Pei et al, Science 269, 1086, 1995, J. Gao, G. Yu, A. J. Heeger, Appl. Phys. Lett. 71, 1293, 1997 and other documents. The AC power source 5 provides the two electrodes 10, 11 with voltage via a first contact 14 and a second contact 15 respectively. The total thickness x of the laminate 4 is about 0.5 mm of which the thickness of the light-emitting layers 12, 13 is typically in the order of 500 Å to 0.2 mm. The layer thickness of each of the light-emitting layers 12, 13 is preferably tuned for sufficient light output. A low thickness is advantageous for several reasons. One reason is that the insulating effect of the laminate 4 is minimized such that heat is effectively transferred from the sole 2 through the laminate 4 and to a garment, which is to be ironed.

The light-emitting layers 12 and 13 comprise a semiconducting matrix and ions, which are movable in the matrix, the mobility of the ions in the matrix being temperature dependent. The matrix is a semiconducting polymeric material in which the mobility of injected holes is higher than that of injected electrons. Examples of suitable semiconducting polymeric materials in which the mobility of holes is larger than that of electrons are poly(phenylene vinylenes) (PPV), poly(para-phenylenes) (PPP) and derivatives thereof. Further alternatives can be found in the patent U.S. Pat. No. 5,682,043 describing light-emitting electrochemical cells in general. The matrix could, as alternative, be made of another type of organic material, such as an organic material having substantially smaller molecular weight than the polymeric materials. The ions could be provided by salts comprising a cation, such as sodium ions, and an anion, such as chlorine ions. As an alternative the ions could be provided by a polymer electrolyte. Different types of ions suitable for a light-emitting electrochemical cell could be found, i.a., in the above mentioned US patent. Further, transition metal complexes, such as ruthenium tris-bipyridine, [Ru(bpy)₃]²⁺, combined with a suitable counter ion may be used as is described by P. McCord and A. J. Bard, J. Electronal. Chem., 318, 91, 1991. The ruthenium tris-bipyridine, [Ru(bpy)₃]²⁺, complex results in the emission of orange-red light, which may be very suitable in many applications were a visual warning of high temperature is desired.

Thus the first light-emitting layer 12 and the second light-emitting layer 13 comprise similar types of organic matrices, which can be polymers, and the same type of ions that can move through both light-emitting layers 12, 13. The first light-emitting layer 12 is however a blue-emitting light-emitting layer, i.e. if a hole and an electron recombines in the first light-emitting layer 12 blue light will be emitted. Correspondingly the second light-emitting layer 13 is a red-emitting light-emitting layer, i.e. if a hole and an electron recombines in the second light-emitting layer 13 red light will be emitted. The colours, blue and red in this case, could either be provided by colouring the respective light-emitting layers with a proper dye, i.e. blue dye and red dye respectively, or choosing matrixes and/or ions that themselves provide the desired colour.

The first electrode 10 is a low work function metal electrode, which is at least partially transparent. Suitable materials for preparing such a partially transparent low work function electrode include thin layers, having a thickness in the range of 20 nm, of barium and calcium and lithiumfluoride. In order to improve the electrical properties and to shield such a layer from environmental impact, such as oxidation, the barium or calcium layer could be coated with a thin silver layer. For example the partially transparent low work function electrode could have a 5 nm thick barium layer having a 15 nm thick silver layer provided on top of it. The fact that the first electrode 10 is a low work function electrode means that the energy gap to be passed in order to inject electrons is small, i.e. injection of electrons from the first electrode 10 into the light-emitting layers 12, 13 is comparably easy.

The second electrode 11 is a high work function electrode, such as an indium tin oxide (ITO) or indium zinc oxide electrode. The fact that the second electrode 11 is a high work function electrode means that the energy gap to be passed in order to inject holes is small, i.e. injection of holes from the second electrode 11 into the light-emitting layers 12, 13 is comparably easy. Further alternative materials for a high work function electrode include, but is not limited to, platinum, gold, silver, iridium, nickel, palladium, and molybdenum.

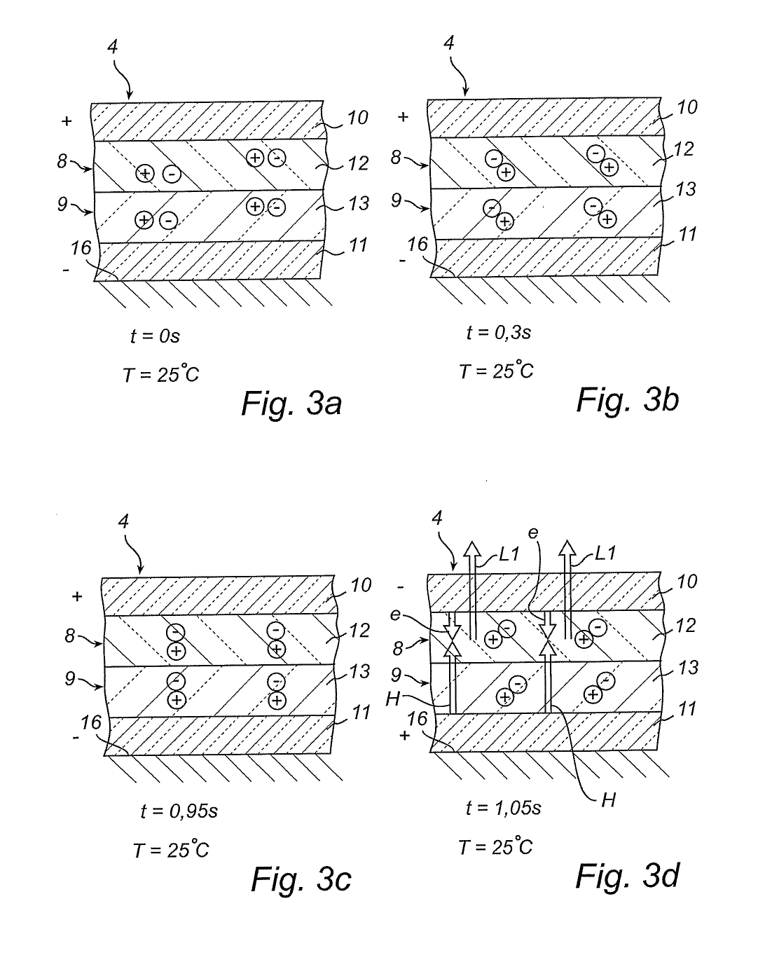

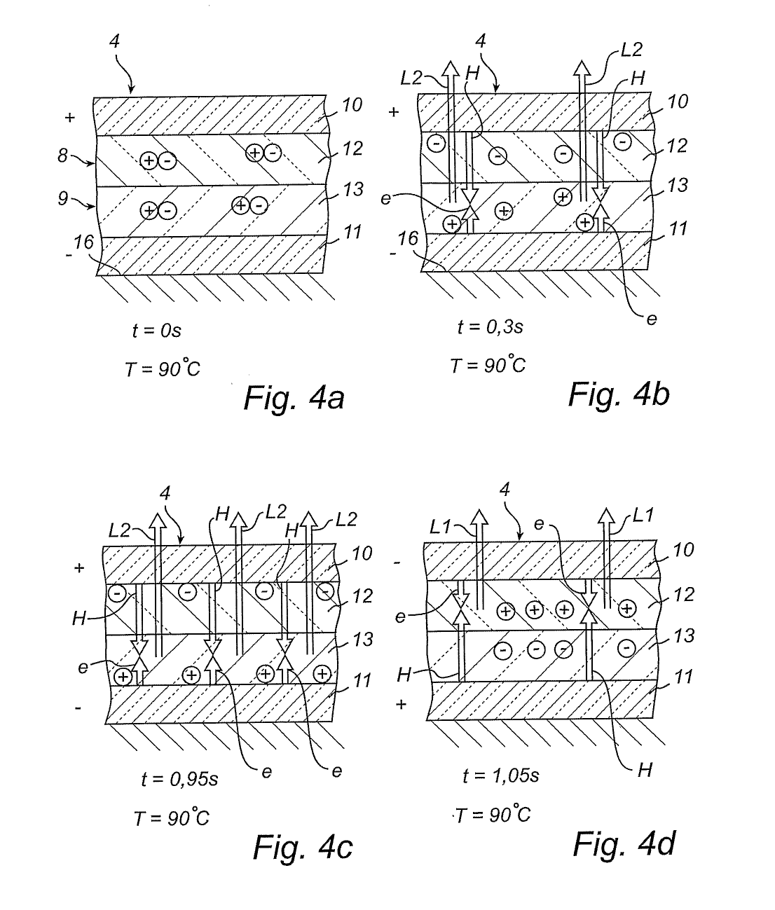

The practical operation, at two different temperatures, of the temperature indicator 1 will now be described in more detail with reference to FIG. 3a to 3d and FIG. 4a to 4d respectively. In the example given the frequency of the AC voltage is constant at 1 Hz, i.e. the polarity of the voltage is alternated once per second.

In the example described with reference to FIG. 3a to 3d the temperature at the surface 16 of the sole 2 is 25° C.

FIG. 3a indicates the situation at the exact moment the power is switched on. The AC power source provides the first electrode 10 with positive charge, making it the anode, and the second electrode 11 with negative charge, making it the cathode. The negative ions, represented by (−), and the positive ions, represented by (+), are at this moment still paired with each other in the light-emitting layers 12, 13. In relation to the low work function first electrode 10 and the high work function second electrode 11 this is a reverse bias resulting in that no holes are injected from the first electrode 10, the anode, and no electrons are injected from the second electrode 11, the cathode.

FIG. 3b indicates the situation 0.3 s after switching on the voltage. As is clear the negative ions are moving, slowly, towards the first electrode 10, the anode, and the positive ions are moving, also slowly, towards the second electrode 11, the cathode.

FIG. 3c indicates the situation 0.95 s after switching on the voltage, i.e. just before the polarity of the AC voltage is to be switched. As can be seen the negative ions have travelled a distance towards the first electrode 10, the anode, but there is no real accumulation of negative ions at the anode and thus no holes are injected into the light-emitting layers 12, 13. Correspondingly there is no accumulation of positive ions at second electrode 11, the cathode, and thus no electrons will be injected either. In the absence of holes and electrons injected there will be no emission of light.

FIG. 3d indicates the situation 1.05 s after switching on the voltage, i.e. just after the polarity has been switched. In relation to the low work function first electrode 10 and the high work function second electrode 11 this is a forward bias resulting in that electrons e are injected from the first electrode 10, the cathode, and holes H are injected from the second electrode 11, the anode. As mentioned above the materials of the light-emitting layers 12, 13 are chosen such that the mobility of the holes H is larger than that of the electrons e. Since the holes H will travel faster through the light-emitting layers 12, 13 than the electrons e the recombination between holes H and electrons e will occur in the first light-emitting layer 12. A recombination of holes H and electrons e in the first light-emitting layer 12 will, as mentioned above, result in the emission of a first type of light L1, i.e. blue light. The negative ions have begun a, slow, travel towards the second electrode 11, now being the anode, and the positive ions have begun a, slow, travel towards the first electrode 10, now being the cathode. As is illustrated in FIG. 3a to 3d the mobility of the ions, which is a diffusion limited process, in the matrix at 25° C. is so slow that no sufficient accumulation of negative ions and positive ions at the anode and at the cathode, respectively, is obtained before the AC power source switches the polarity of the voltage. Thus, at the conditions illustrated in FIG. 3a-3d, the light emitting laminate 4 will emit blue light L1 when in a forward bias, i.e. when the low work function first electrode 10 is the cathode and the high work function second electrode 11 is the anode, and no light at all will be emitted in the reverse bias, i.e. when the low work function first electrode 10 is the anode and the high work function second electrode 11 is the cathode. Consequently at 25° C. the temperature indicator 1 will emit a flashing blue light L1 indicating to the user that power is switched on but that the sole 2 of the iron 3 is still cold.

In the example described with reference to FIG. 4a to 4d the temperature at the surface 16 of the sole 2, and in the laminate 4, is 90° C.

FIG. 4a indicates the situation at the exact moment the power is switched on. The AC power source provides the first electrode 10 with positive charge, making it the anode, and the second electrode 11 with negative charge, making it the cathode. The negative ions, represented by (−), and the positive ions, represented by (+), are at this moment still paired with each other.

FIG. 4b indicates the situation 0.3 s after switching on the voltage. Due to the high mobility of the ions in the matrix at this increased temperature there is already at this occasion a rather large accumulation of negative ions at the first electrode 10, the anode, and of positive ions at the second electrode 11, the cathode. Due to the accumulation of ions, forming large ion density gradients at the electrodes, electrons e are injected at the second electrode 11, the cathode, in spite of the fact that this is a high work function electrode, and holes H are injected at the first electrode 10, the anode, in spite of the fact that this is a low work function electrode. Since the holes H will travel faster through the light-emitting layers 12, 13 than the electrons e, due to the higher mobility of the holes H in the materials in question, the recombination between holes H and electrons e will occur in the second light-emitting layer 13. A recombination of holes H and electrons e in the second light-emitting layer 13 will, as mentioned above, result in the emission of a second type of light L2, i.e. red light.

FIG. 4c indicates the situation 0.95 s after switching on the voltage, i.e. just before the polarity of the AC voltage is to be switched. As can be seen there is a large accumulation of negative ions at the first electrode 10, the anode, and a large accumulation of positive ions at the second electrode 11, the cathode. The large ion gradients thereby formed at the respective electrodes 10, 11 provides for efficient injection of holes H and electrons e, respectively, and thus much red light L2 is emitted by the laminate 4 by recombination of these electrons e and holes H in the second light-emitting layer 13.

FIG. 4d indicates the situation 1.05 s after switching on the voltage, i.e. just after the polarity has been switched. In relation to the low work function first electrode 10 and the high work function second electrode 11 this is a forward bias resulting in that electrons e are injected from the first electrode 10, the cathode, and holes H are injected from the second electrode 11, the anode. Thus a blue light L1 will be emitted in accordance with the same principles as was described above with reference to FIG. 3d. It can be seen from FIG. 4d that the negative ions have started a rather quick travel towards the second electrode 11, the anode, and that the positive ions have started a rather quick travel towards the first electrode 10, the cathode. This will cause an accumulation of positive ions and negative ions at the cathode and the anode, respectively, but this will not have any substantial effect on the already quite efficient injection of holes and electrons in this forward bias.

As is illustrated in FIG. 4a to 4d the mobility of the ions, which is a diffusion limited process, in the matrix at 90° C. is quick enough to provide sufficient accumulation of negative ions and positive ions at the anode and at the cathode, respectively, before the AC power source switches the polarity of the voltage. Thus, at the conditions illustrated in FIG. 4a-4d, the light emitting laminate 4 will emit blue light L1 when in a forward bias, i.e. when the low work function first electrode 10 is the cathode and the high work function second electrode 11 is the anode, according to the principles of the light-emitting diode 8. When in the reverse bias, i.e. when the low work function first electrode 10 is the anode and the high work function second electrode 11 is the cathode, the accumulation of positive ions and negative ions at the respective electrode 10, 11 will cause an ion gradient sufficient to provide injection of holes H from the low work function first electrode 10 and electrons e from the high work function second electrode 11, resulting in the light-emitting laminate 4 emitting red light L2 according to the principles of the light-emitting electrochemical cell 9. Consequently at 90° C. the temperature indicator 1 will emit a flashing light alternating between red and blue light indicating to the user that power is switched on and that the sole 2 of the iron 3 is hot.

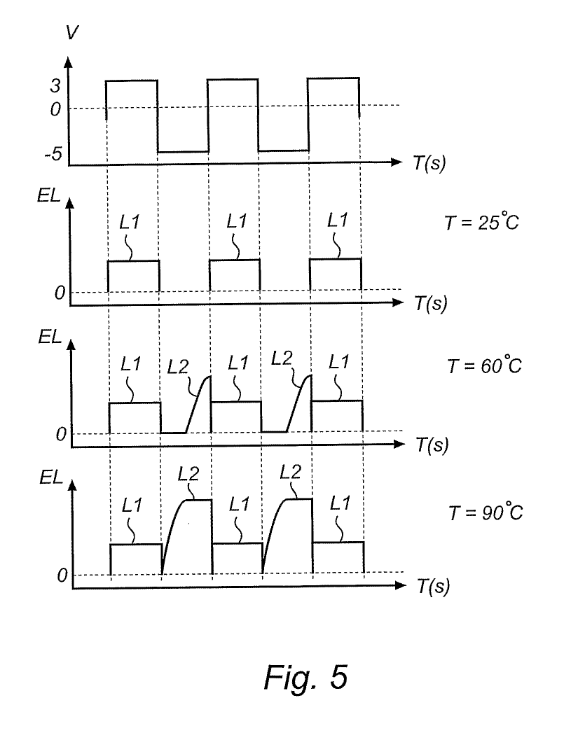

FIG. 5 indicates the electro-luminescence EL of the light-emitting laminate 4 at different temperatures. The AC power source provides the laminate 4 with a voltage V of +3/−5 V and shifts the polarity at a constant frequency of 1 Hz. At 25° C. a blue light L1 is emitted in the forward bias, at a voltage of +3 V, according to the principles of the light-emitting diode 8. The mobility of the ions in the matrix is too slow to provide a sufficient accumulation of ions at the respective electrode in the reverse bias and thereby no light is emitted in the reverse bias mode. At 60° C. the ions move rather fast in the matrix and thus emission of red light L2 starts about 0.5 s after the polarity has been switched to “−”, i.e in the reverse bias, at a voltage of −5 V, according to the principles of the light-emitting electrochemical cell 9. The red light L2 emission continues, with an increasing intensity, for about 0.5 s until the polarity is switched to forward bias resulting in the emission of blue light L1 again. At 90° C. the ions move so fast that a sufficient accumulation of ions is obtained almost directly after switching the voltage to “−”. As is indicated in FIG. 5 the temperature indicator provides, at 60° C., a flashing effect in which blue light L1 is followed by a dark period of 0.5 s, then by 0.5 s of red light L2 emission. This flashing behaviour is easily observed by the user and reduces the risk that a warning of high temperature is missed. At higher temperatures, such as 90° C., the dark period is almost wiped out providing an almost direct alternation between blue light L1 and red light L2. The temperature indicator does thus not only indicate that a surface is hot but also provides additional information on the actual temperature of the surface. Since the voltage, in absolute numbers, is higher in reverse bias than in forward bias the red light L2 will outdo the blue light L1 giving a mainly reddish impression at high temperatures. As alternative to having a higher absolute voltage in reverse bias than in forward bias it is also possible to have a mixed frequency, i.e. a frequency in which the pulse length is longer in the reverse bias than in the forward bias in order to provide the desired reddish impression at high temperatures. Yet another alternative is to both have a higher voltage and a longer pulse length in the reverse bias to further boost the intensity of the red light.

At higher AC voltage frequencies, such as frequencies of about 50 Hz and above, the eye will, at higher temperatures, perceive a more or less mixed colour which, depending on the intensity of the red light and the blue light, could be more or less magenta or, at low blue light intensities, even almost purely red.

The frequency of the AC power source 5 is tuned in such a way that with the thickness of the light-emitting layer, the type of matrix and the ions in question, red light L2 emission is obtained when the temperature exceeds a predetermined temperature, i.e. the threshold temperature. If, for example, it would be desired that red light emission would start only at temperatures of 70° C. and higher, i.e. the threshold temperature is 70° C., the frequency of the AC power source could be increased from 1 Hz to for example 3 Hz. In such a case the accumulation of ions at 60° C. would not be sufficient for red light emission. As alternative to increasing the frequency it is also possible to make the light-emitting layer layer thicker, exchange the matrix material for one in which the ions move slower and/or exchange the ions for a type which have lower mobility. Thus there are several ways to provide a temperature indicator, which provides red light emission over a desired threshold temperature.

In the case the surface 16 of the sole 2 does not have an even temperature all over said surface 16 the light emission of the light-emitting electrochemical cell 9 will vary over the area. Thus a part of the surface having a high temperature, e.g. 90° C., will result in an intense light-emission from the part of the light-emitting electrochemical cell 9 that covers that part of the surface 16 while another part of the surface 16 having a lower temperature, e.g. 60° C., will result in a faint light-emission from the part of light-emitting electrochemical cell 9 that covers that part of the surface 16. Thus the user of the appliance will visually see what parts of the surface 16 that have the highest temperatures and which parts that have a lower temperature. Thereby the additional advantage of indicating the presence of local hot spots on a surface is provided by the light-emitting electrochemical cell 9.

Optionally the temperature indicator 1 could be provided with the frequency modulator 7, which is indicated in FIG. 1, for modulating the frequency of the AC power source in order to make it possible for the end user to set the temperature at which red light emission should begin.

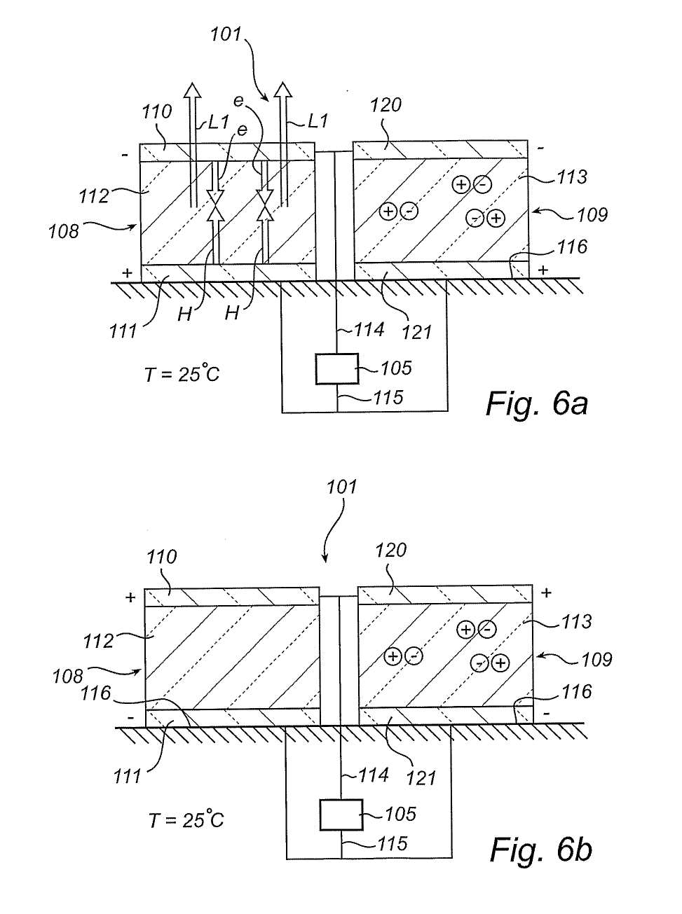

FIG. 6a is a schematic illustration of a temperature indicator 101 according to a second embodiment of the present invention. The temperature indicator 101 comprises a light-emitting diode 108 and a light-emitting electrochemical cell 109. The light-emitting diode 108 has a low work function first electrode 110, a high work function second electrode 111 and a semiconducting first light-emitting layer 112, which is adapted for the emission of blue light L1, sandwiched between the electrodes 110, 111. The light-emitting electrochemical cell 109 comprises a first electrode 120, a second electrode 121 and a second light-emitting layer 113, which is adapted for the emission of red light L2, sandwiched between the electrodes 120, 121. The second light-emitting layer 113 comprises a matrix and ions that are movable within the matrix. The diode 108 and the cell 109 could be placed adjacent to each other or at some distance and at least one of the electrodes of the cell 109, in the example the second electrode 121, is placed in contact with a surface 116, such as the sole of an iron, the temperature of which is to be indicated. An AC power source 105 provides the first electrode 110 of the diode 108 and the first electrode 120 of the cell 109 with voltage via a first contact 114, and the second electrode 111 of the diode 108 and the second electrode 121 of the cell 109 via a second contact 115. Consequently the diode 108 and the cell 109 are electrically coupled in parallel with each other. The polarity of the voltage supplied by the AC power source 105 is switched with a frequency of about 1 Hz. The first electrode 110 and the first electrode 120 are both made from a transparent material. The first electrode 110, being a low work function electrode, could comprise, as example, a 5 nm barium layer, coated with 15 nm silver. At the conditions indicated in FIG. 6a the temperature at the surface 116 is 25° C. and the first electrodes 110, 120 are provided with a negative voltage, i.e. the first electrodes 110, 120 are cathodes, whereas the second electrodes 111, 121 are anodes. In this situation, which is a forward bias as regards the diode 108, the low work function first electrode 110 of the diode 108 injects electrons e into the first light-emitting layer 112 and the high work function second electrode 111 injects holes H into the first light-emitting layer 112. In the light-emitting layer 112 the holes H and electrons e recombine resulting in the emission of blue light, L1, being emitted via the transparent first electrode 110.

Due to the low mobility of the ions in the second light-emitting layer 113 at this low temperature no accumulation of ions near the electrodes 120, 121 of the cell 109 will be obtained and consequently no light will be emitted by the cell 109.

FIG. 6b shows the temperature indicator 101 after the polarity of the voltage has changed in comparison to the situation in FIG. 6a. At this occasion the first electrodes 110, 120 are provided with a positive charge, i.e. they are anodes, and the second electrodes 111, 121 are provided with a negative charge, i.e. they become cathodes. As regards the light-emitting diode 108 this is a reverse bias and no light will be emitted. As regards the light-emitting electrochemical cell 109 the mobility of the ions is, as described above, too slow at the frequency of the AC power source 105 to provide the necessary accumulation of ions.

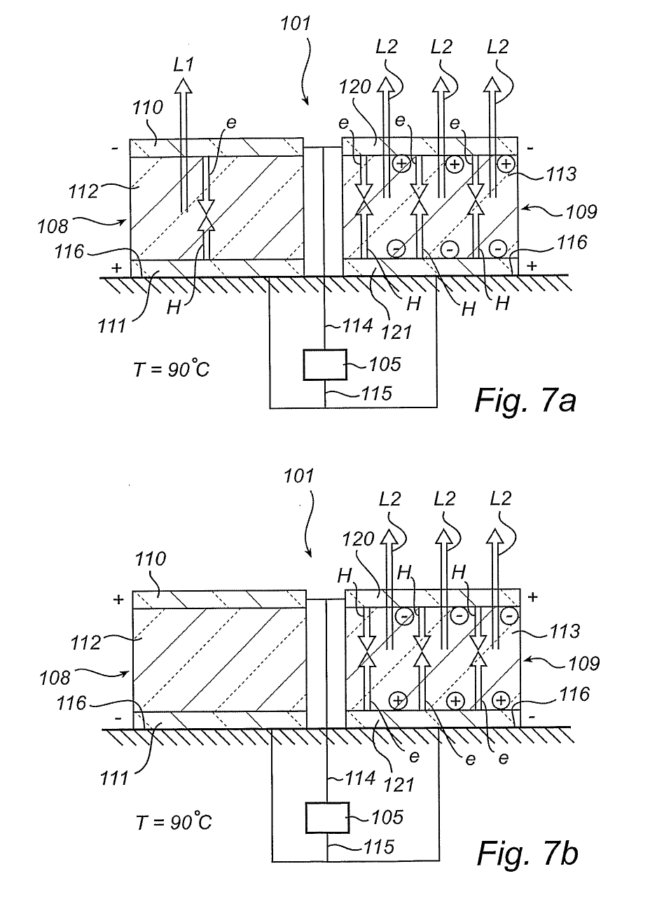

FIG. 7a shows the temperature indicator 101 at a temperature at the surface 116 of 90° C. The AC power source 105 provides the first electrodes 110, 120 with a negative charge, making them cathodes, and the second electrodes 111, 121 with a positive charge making them anodes. At this temperature the mobility of ions is high in the matrix of the second light-emitting layer 113 and thus an accumulation of positive ions is quickly obtained at the first electrode 120 of the light-emitting electrochemical cell 109 and an accumulation of negative ions is obtained at the second electrode 121. The high ion gradients thereby obtained result in the injection of electrons e from the first electrode 120 and the injection of holes H from the second electrode 121. As the holes H and the electrons e recombine in the second light-emitting layer 113 a red light L2 is emitted by the light-emitting electrochemical cell 109. The light L2 is transmitted via the transparent electrode 120 and provides a visual indication that the surface 116 is hot. As regards the light-emitting diode 108 it will, since the conditions indicated in FIG. 7a is a forward bias, emit blue light L1 according to the principles described with reference to FIG. 6a. However, at the temperature of 90° C. the high mobility of the ions in the light-emitting layer 113 of the light-emitting electrochemical cell 109 as well as the improved charge injection efficiency, that allows an efficient flow of charge carriers between the cathode and the anode, will substantially decrease the resistance in that cell 109. Thereby, since the diode 108 and the cell 109 are coupled in parallel, the current will mainly flow via the low resistance path, i.e. via the cell 109, and thus the intensity of the blue light L1 emitted by the diode 108 is substantially decreased compared to the intensity obtained at lower temperatures. Thus the temperature indicator 101 provides an automatic dimming of the blue light L1 emitted by the diode 108 as the temperature increases.

FIG. 7b shows the situation at 90° C. after the polarity has been switched. As regards the light-emitting diode 108 this is a reverse bias and no light is emitted. The first electrode 120 of the light-emitting electrochemical cell 109 injects holes H due to the accumulation of negative ions and the second electrode 121 injects electrons e due to the accumulation of positive ions. The holes H and electrons e recombine in the second light-emitting layer 113 to produce a red light L2.

Thus, at a temperature of 90° C. a high intensity red light L2 is emitted by the temperature indicator 101 in both reverse and forward bias, whereas a rather faint blue light L1 is emitted in the forward bias. The blue light L1 is outdone by the red light L2 clearly indicating to the user that the surface 116 is hot.

In the embodiment shown in FIGS. 6a-b and FIGS. 7a-b the first electrode 110 of the diode 108 is separated from both electrodes 120, 121 of the cell 109 and so is the second electrode 111 of the diode 108. It will be appreciated however that, as an alternative and with the same technical effect, the first electrode of the diode could be common with the first electrode of the cell or that the second electrode of the diode could be common with the second electrode of the cell. For example one common second electrode could be located on the surface 116 and then a first light-emitting layer and a second light-emitting layer could be placed, at a distance from each other, on this common second electrode and have separate first electrodes. Thus it is sufficient that at least one of the electrodes of the diode is separate from the electrodes of the cell.

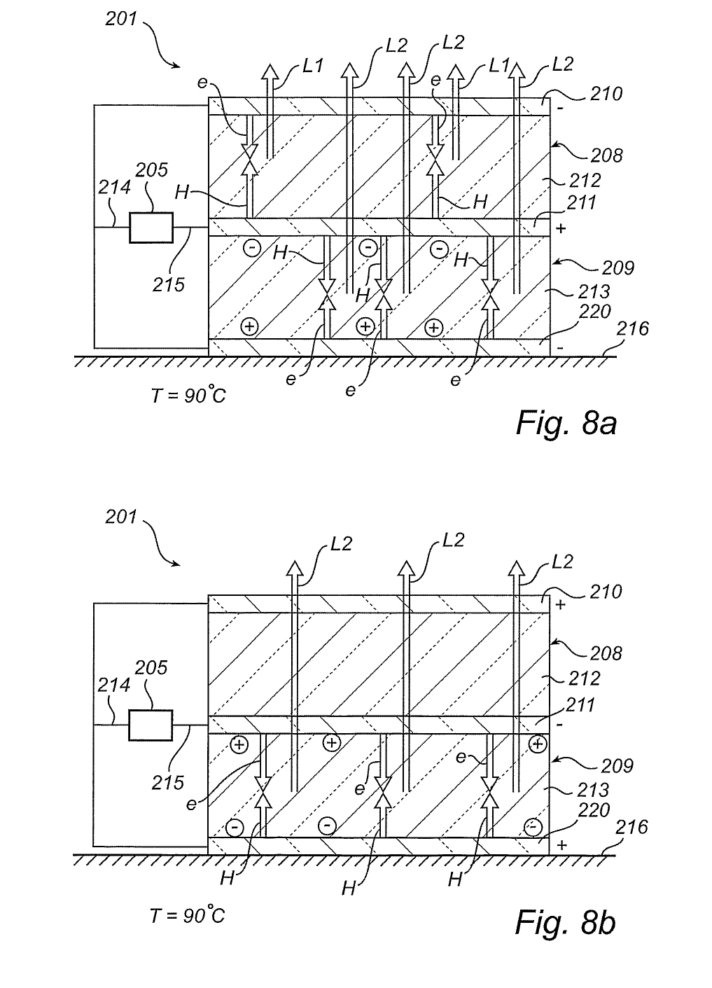

FIG. 8a is a schematic illustration of a temperature indicator 201 according to a third embodiment of the present invention. The temperature indicator 201 comprises a light-emitting diode 208 and a light-emitting electrochemical cell 209. The light-emitting diode 208 has a low work function first electrode 210, a high work function second electrode 211 and a semiconducting first light-emitting layer 212, which is adapted for the emission of blue light L1, sandwiched between the electrodes 210, 211. The light-emitting electrochemical cell 209 comprises a first electrode 220, the second electrode 211, which is thus common with that of the diode 208, and a second light-emitting layer 213, which is adapted for the emission of red light L2, sandwiched between the electrodes 220, 211. The second light-emitting layer 213 comprises a matrix and ions that are movable within the matrix. The diode 208 and the cell 209 are thus placed on top of each other and their respective light-emitting layers 212, 213 are separated by the common high work function second electrode 211. The first electrode 220 of the cell 209 is placed in contact with a surface 216, such as the sole of an iron, the temperature of which is to be indicated. An AC power source 205 operating at a frequency of 1 Hz provides the first electrode 210 of the diode 208 and the first electrode 220 of the cell 209 with voltage via a first contact 214, and the common second electrode 211 via a second contact 215. Consequently the diode 208 and the cell 209 are electrically coupled in parallel with each other. The polarity of the voltage supplied by the AC power source 205 is switched with a frequency of about 1 Hz. The low work function first electrode 210 and the common high work function second electrode 211 are both made from transparent materials. The low work function first electrode 210 may for example be made of a thin layer of barium or calcium and the high work function second electrode 211 may be made of indium tin oxide (ITO).

At the conditions indicated in FIG. 8a the temperature at the surface 216 is 90° C. and the first electrodes 210, 220 are provided with a negative voltage, i.e. the first electrodes 210, 220 are cathodes, whereas the common second electrode 211 is an anode. In this situation, which is a forward bias as regards the diode 208, the low work function first electrode 210 of the diode 208 injects electrons e into the first light-emitting layer 212 and the high work function second electrode 211 injects holes H into the first light-emitting layer 212. In the light-emitting layer 212 the holes H and electrons e recombine resulting in the emission of blue light, L1, being emitted via the transparent first electrode 210.

At a temperature of 90° C. the mobility of ions is high in the matrix of the second light-emitting layer 213 and thus an accumulation of positive ions is quickly obtained at the first electrode 220 of the light-emitting electrochemical cell 209 and an accumulation of negative ions is obtained at the second electrode 211. The high ion gradients thereby obtained result in the injection of electrons e from the first electrode 220 and the injection of holes H from the second electrode 211 which, according to similar principles described above with reference to FIG. 7a results in the emission of a red light L2, which is transmitted via the transparent electrodes 211 and 210, by the light-emitting electrochemical cell 209. Thus at the conditions shown in FIG. 8a a mixed light comprising blue light L1 and red light L2 is emitted. Since the diode 208 and the cell 209 are coupled in parallel with each other and since the resistance of the cell 209 decreases with temperature leading to an increasing current going through the cell 209 and a decreasing current going through the diode 208, the blue light L1 will be dimmed at higher temperatures leading to the emission of a mainly reddish light from the temperature indicator 201.

FIG. 8b shows the temperature indicator 201 after the polarity of the voltage has changed in comparison to the situation in FIG. 8a. At this occasion the first electrodes 210, 220 are provided with a positive charge, i.e. they are anodes, and the common second electrode 211 is provided with a negative charge, i.e. it becomes the cathode. As regards the light-emitting diode 208 this is a reverse bias and no light will be emitted. As regards the light-emitting electrochemical cell 209 the mobility of the ions is sufficient for providing a red light L2 emission also in this bias according to the principles described above. It will be appreciated that, at low temperatures such as 25° C., the light-emitting electrochemical cell 209 will not emit any light due to the low mobility of ions at such temperatures. Thus the temperature indicator 201 will, at low temperatures, provide a flashing blue light L1 provided by the diode 208. At higher temperatures the light-emitting electrochemical cell 209 will start to emit red light L2, both in forward bias and reverse bias, and, at the same time, the blue light L1 will be dimmed.

As alternative to the embodiment of FIG. 8a it is of course also possible to make use of high work function first electrodes and a common low work function second electrode.

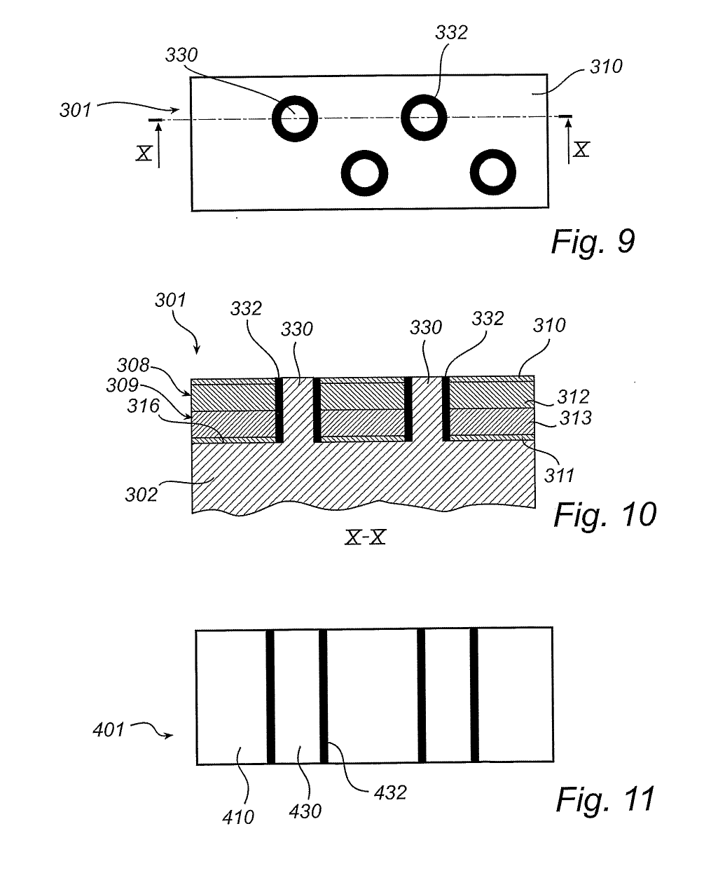

FIG. 9 is a top view and shows an alternative temperature indicator 301. The temperature indicator 301, which is shown in cross-section in FIG. 10, is rather similar to the indicator 1 shown in FIG. 2 and thus the temperature indicator has a first electrode 310, a second electrode 311 and first and second light-emitting layers 312, 313 sandwiched between the electrodes 310, 311 thereby forming a light-emitting diode 308 and a light-emitting electrochemical cell 309. The second electrode 311 is attached to a surface 316 of a sole 302 of an iron (not shown in FIG. 9). Cylindrical thermal contacts 330 extend from the sole 302 through the diode 308 and the cell 309. The purpose of these contacts 330 is to improve the transfer of heat from the sole 302 to the garment that is to be ironed. Thus the contacts 330 decrease the insulating effect of the diode 308 and the cell 309 and permits the use of a layers 312, 313 and electrodes 310, 311 with a higher thickness without deteriorating the function of the iron. The thermal contact 330 is electrically insulated from the diode 308 and the cell 309 by means of a sleeve 332 made of an electrically insulating material, such as a non-conductive polymer.

FIG. 11 is a top view and indicates yet another alternative temperature indicator 401. The indicator 401 is similar to the indicator 301 shown in FIG. 9 and 10 with the exception that the indicator 401 is provided with bar shaped thermal contacts 430 extending through a first electrode 410, first and second light-emitting layers and a second electrode (the latter ones not being shown in FIG. 11), forming together a light-emitting diode and a light-emitting electrochemical cell, the thermal contact 430 being electrically insulated from the diode and the cell by means of an insulating sleeve 432.

In the embodiments of FIGS. 9-11 thermal contacts are shown. As alternative the light-emitting electrochemical cell and/or the light-emitting diode of a temperature indicator could be perforated for the reason of enabling a user to see through the light-emitting electrochemical cell and/or the diode, such as in the case the temperature indicator is used for an oven window or for a water cooker. The perforations in such a temperature indicator could be filled with glass beads through which a user could look into e.g. the oven.

Further it will be appreciated that thermal contacts may also be used in the embodiment shown in FIG. 6a-b and FIG. 7a-b and in the embodiment shown in FIG. 8a-b. In the case of the embodiment shown in FIG. 6a-b and FIG. 7a-b thermal contacts could be provide in the light-emitting electrochemical cell only or in both the cell and the diode.

It will be appreciated that numerous variants of the above-described embodiments are possible within the scope of the appended patent claims.

For example in the embodiment shown above with reference to FIG. 1-4 the light-emitting diode 8 emits blue light L1. It is also possible to use a light-emitting diode that emits light of another wave-length, e.g. green light. It will also be appreciated that it is possible to use completely different colours depending on which messages should be provided by the temperature indicator.

The embodiments illustrated in FIGS. 1-4, FIGS. 8a-b and FIGS. 9-10 have the red-emitting layer 13, 213, and 313, respectively, located closest to the hot surface 16, 216, and 316, respectively, and the blue-emitting layer 12, 212, and 312, respectively, located on top of the red-emitting layer. Although this is a preferred way of stacking the layers it will be appreciated that it is also possible to stack the layers in another way, such as the red-emitting layer on top of the blue-emitting layer, combining them with high and low work function electrodes in a proper way.

In the embodiment shown in FIG. 1-4 the blue light L1 or red light L2 is emitted through the first electrode 10. As alternative the first electrode could be put against the hot surface, the light emitted would then be emitted through a transparent second electrode. Still another alternative would be to allow the red and blue light emitted to be emitted directly via the sides of the light-emitting layers 12, 13 and not through one of the electrodes.

In order to provide the temperature indicator with electrical protection, mechanical scratch protection or protection against water it could be provided with a thin protective top coating, such as a thin polymer layer provided on the first electrode or even hermetically encapsulating the entire light-emitting electrochemical cell.

The matrix material in the light-emitting layers 12, 13 is such that the mobility of the holes is larger than that of the electrons. It is, as an alternative, also possible to use a matrix material in which the mobility of the electrons is larger than that of the holes and make the first and second light-emitting layers change place with each other.

The frequency of the AC power source is adapted to fit the actual temperature level at which light emission from the electrochemical cell should start and the actual light-emitting electrochemical cell. In most cases it has proven suitable with a frequency in the range of 0.5-10 Hz to provide a temperature indicator with sufficiently quick response and high visibility. However the usable frequency range may be extended to higher values, such as up to about 100 Hz, depending on the materials used, the geometry of the light-emitting electrochemical cell etc.

Above it is described that the first type of light is a first colour, e.g. green or blue, and that the second type of light has another colour, e.g. red or orange. It is of course also possible to have a first type of light that has the same wave length, i.e. colour, as the second type of light but a different intensity and/or frequency. Different wave lengths, i.e. colours, are however advantageous since they decrease the risk of a user misunderstanding the message given. Furthermore it is also possible to combine the light-emitting electrochemical cell and/or the light-emitting diode with colour filters in order to obtain the desired colours.

To summarize a temperature indicator is adapted to be provided on a surface for providing a first type of light emission and a second type of light emission. The temperature indicator comprises a light-emitting diode for providing said first type of light emission and a light-emitting electrochemical cell for providing said second type of light emission. The light-emitting electrochemical cell has a first electrode, a second electrode and a second light-emitting layer being sandwiched between them and comprising a matrix and ions being movable in the matrix, the mobility of said ions in said matrix being temperature dependent. A power source is adapted for driving the light-emitting electrochemical cell with an AC voltage, the frequency of which is tuned in such a way that the light-emitting electrochemical cell provides said second type of light emission when the surface temperature exceeds a certain level.

1. A temperature indicator adapted to be provided on a surface for providing a first type of light emission and a second type of light emission, the latter being emitted when the surface has a temperature being higher than a predetermined temperature, the temperature indicator comprising a light-emitting diode for providing said first type of light emission, the light-emitting diode having a first electrode, a second electrode and a first light-emitting layer being positioned between them, the temperature indicator further comprising a light-emitting electrochemical cell for providing said second type of light emission, the light-emitting electrochemical cell having a first electrode, a second electrode a second light-emitting layer being positioned between them and comprising a matrix and ions being movable in the matrix, the mobility of said ions in said matrix being temperature dependent, the temperature indicator further comprising a power source adapted for driving the light-emitting electrochemical cell with an AC voltage, the frequency of which is tuned in such a way that the light-emitting electrochemical cell provides said second type of light emission when the surface temperature exceeds a certain level.

2. The temperature indicator of claim 1, said first light-emitting layer and said second light-emitting layer being placed on top of each other, the light-emitting diode and the light-emitting electrochemical cell having at least one common electrode.

3. The temperature indicator of claim 1, wherein at least one of the first electrode and the second electrode of the light-emitting diode is separated from the first electrode and the second electrode of the light-emitting electrochemical cell.

4. The temperature indicator of claim 2, wherein the light-emitting diode (8) and the light-emitting electrochemical cell (9) have both electrodes 10, 11) in common.

5. The temperature indicator of claim 4, wherein the mobility of holes (H) in said first and second light-emitting layers is different from the mobility of electrons (e) therein.

6. The temperature indicator of claim 2, wherein at least one of said electrodes is a low work function electrode and at least one of said electrodes is a high work function electrode.

7. The temperature indicator of claim 2, wherein the first light-emitting layer and the second light-emitting layer are separated by a common electrode.

8. The temperature indicator of claim 3, the light-emitting diode and the light-emitting electrochemical cell being arranged in parallel from an electrical point of view, the AC power source driving both the light-emitting diode and the light-emitting electrochemical cell.

9. The temperature indicator of claim 1, wherein the AC power source is adapted to drive the light-emitting electrochemical cell with a pulse length which is longer than the pulse length with which the light-emitting diode is driven.

10. The temperature indicator of claim 1, wherein the AC power source is adapted to drive the light-emitting electrochemical cell with a current which is sufficiently high that the light-emitting electrochemical cell gives a light output, that is higher than the light output of the light-emitting diode.

11. The temperature indicator of claim 1, wherein the second type of light emission is different from the first type of light emission as regards the colour point and/or intensity of the light emitted.

12. The temperature indicator of claim 1, wherein the temperature indicator (1) is adapted to cover substantially the entire potentially hot surface of an appliance (3), the temperature indicator (1) indicating which parts of said surface that are hot.

13. The temperature indicator of claim 1, wherein the temperature indicator is provided with thermal contacts, that extend through the light-emitting electrochemical cell and are adapted to conduct heat through said cell.
